(19) United States
(12) Patent Application Publication
(10) Pub. No.: US 2001/0024367 A1
(43) Pub. Date: Sep. 27, 2001

(54) Multi-function torch

(76) Inventor: Wen-Chin Shiau, Tao-Yuan Hsien (TW)

Correspondence Address: OHLANDT,GREELEY, RUGGIERO & PERLE, L.L.P., 10th Floor, One Landmark Square, Stamford, CT, 06901-2682, US

(21) Appl. No.: 09/748,945

(22) Filed: Dec. 27, 2000

(30) Foreign Application Priority Data
Mar. 22, 2000 (TW) 089204646

(51) Int. Cl. F21L 4/00

(52) U.S. Cl. 362/188; 362/171; 362/173

(57) ABSTRACT

A torch includes a barrel accommodating a battery unit therein, a lamp seat unit mounted at a front end of the barrel and composed of a tubular seat member, a lamp and a lamp positioning plate, a tubular coupling member made of a light transmittable material and sleeved around the lamp seat, and a head cap secured to a front end of the coupling member and provided with a reflector. The coupling member is axially shiftable relative to the lamp seat between a first position, where the lamp extends into the reflector so that light may be directed axially, and a second position, where the lamp is located in the coupling member and is partially withdrawn from the reflector so that light can pass radially through the coupling member.

### BACKGROUND OF THE INVENTION

1. Field of the Invention

The invention relates to a torch, more particularly to a multi-function torch which can serve as a flashlight and as a lantern or signaling baton, which has a waterproofing effect, and which facilitates mounting of a lamp bulb on a lamp seat unit.

2. Description of the Related Art

Referring to FIGS. 1 to 3, a conventional multi-function lighting device disclosed in U.S. Pat. No. 5,412,548 is shown to include a head section 10 and a handle 11. The head section 10 includes a slidable coupling 100, an axially extending elongate sleeve 101, and an end cap 103 provided with a reflector 102. The head section 10 is removably mounted on one end of the handle 11, which is provided with a lamp 110, and is longitudinally shiftable over the handle 11. When the head section 10 is shifted to a position wherein the lamp 110 is located in the reflector 102, as shown in FIG. 2, the lighting device can be used as a flashlight With reference to FIG. 3, when the head section 10 is shifted to another position wherein the lamp 110 is located in the sleeve 101, the lighting device can be used as a signaling baton. However, the head section 10 of the conventional lighting device cannot be maintained at a desired position to provide a desired focusing effect. Moreover, the conventional lighting device lacks a waterproofing effect.

FIG. 4 shows a conventional lighting device disclosed in U.S. Pat. No. 5,765,937, which comprises a barrel 12 and a head assembly 13 mounted on a front end of the barrel 12. The head assembly 13 includes a coupling member 130, a light-transmittable sleeve member 131, a head cap 132, a seal ring 133, and an annular cap 134. The coupling member 130 is provided with a plurality of projections 135 that are slidable along splines 136 formed on the inner wall surface of the sleeve member 131 such that the sleeve member 131 is shiftable relative to and is rotatable with the coupling member 130 to permit adjustment of focusing. Although the desired focusing can be maintained and a waterproofing effect is provided due to the presence of the seal ring 133, the construction of the lighting device is relatively complicated as it requires both the seal ring 133 and the annular cap 134. Improvements thereon are therefore necessary.

### SUMMARY OF THE INVENTION

Therefore, the primary object of the present invention is to provide a multi-function torch that can serve as a flashlight and as a lantern or signaling baton, and that has a waterproofing effect.

Another object of the present invention is to provide a multi-function torch that can facilitate mounting and positioning of a lamp therein.

Accordingly, a torch of this invention includes a barrel, a lamp seat unit, a tubular coupling member and a head cap. The barrel is adapted to receive a battery unit therein, and has a front end portion and a rear end portion opposite to the front end portion in an axial direction. The lamp seat unit includes a tubular seat member, a lamp positioning plate, and a lamp. The seat member is mounted on the front end portion of the barrel, and has a front section formed with a key projection, and a rear section opposite to the front section in the axial direction. The lamp positioning plate is disposed in the front section of the seat member. The lamp is held by the lamp positioning plate. The coupling member is made of a light transmittable material, and has a front end, a rear end and an annular inner wall surface between the front and rear ends. The inner wall surface is formed with a spline groove. The coupling member is sleeved around the seat member such that the key projection extends into and is slidable along the spline groove. The rear end of the coupling member is formed with a radial inward end flange that contacts tightly and slidingly the seat member. The coupling member is axially shiftable relative to the seat member between a first position, where the end flange contacts the rear section of the seat member, and a second position, where the end flange abuts against the key projection to prevent removal of the coupling member from the seat member. The head cap is secured to the front end of the coupling member and is provided with a reflector therein. The lamp extends into the reflector so that light may be directed axially when the coupling member is disposed at the first position. The lamp is located in the coupling member and is at least partially withdrawn from the reflector so that light can pass radially through the coupling member when the coupling member is disposed at the second position.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded side elevation view of a conventional multi-function lighting device disclosed in U.S. Pat. No. 5,412,548;

FIG. 2 is a side elevation view of the conventional lighting device shown in FIG. 1 when operated in a flashlight mode;

FIG. 3 is a side elevation view of the conventional lighting device shown in FIG. 1 when operated as a signaling baton;

FIG. 4 is an exploded fragmentary perspective view showing a head assembly of a conventional multi-function lighting device disclosed in U.S. Pat. No. 5,765,937;

FIG. 5 is a fragmentary exploded perspective view of the preferred embodiment of a multi-function torch according to the invention;

FIG. 6 is a fragmentary sectional view of the preferred embodiment when operated as a flashlight; and

FIG. 7 is a fragmentary sectional view of the preferred embodiment when operated as a lantern or signaling baton.

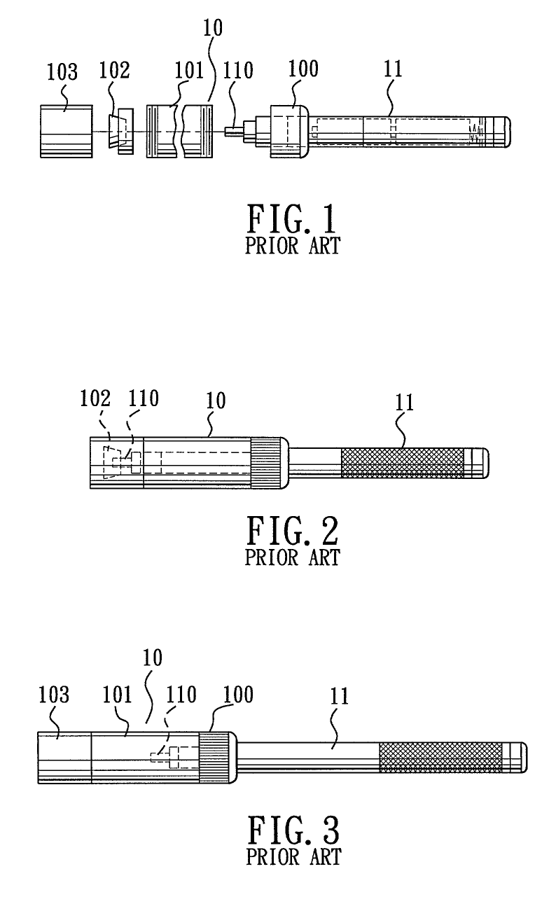

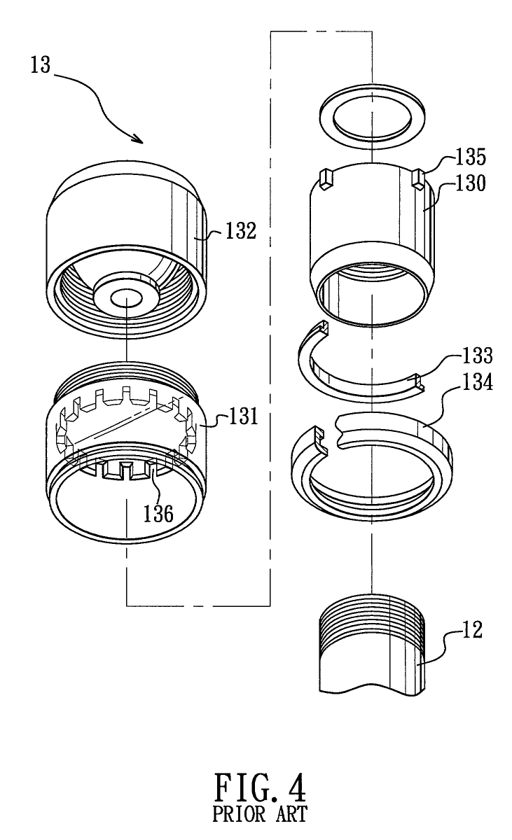

### DETAILED DESCRIPTION OF THE PREFERRED EMBODIMENT

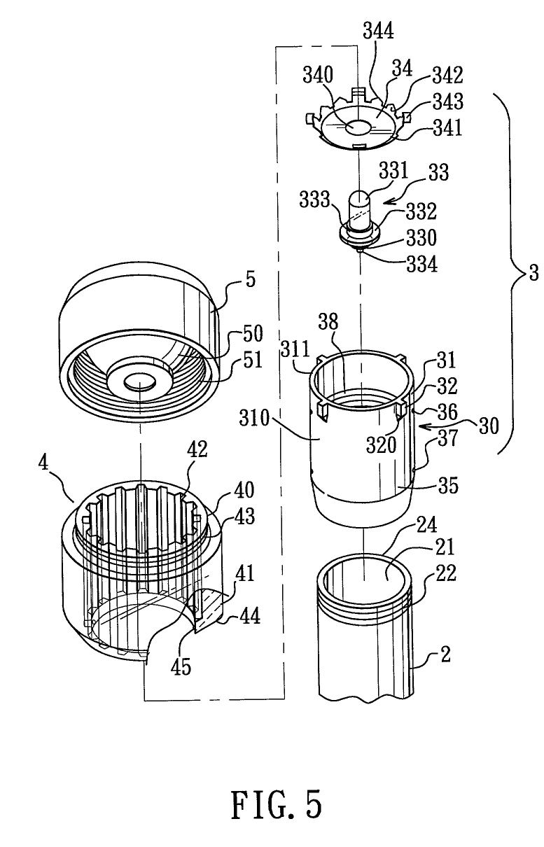

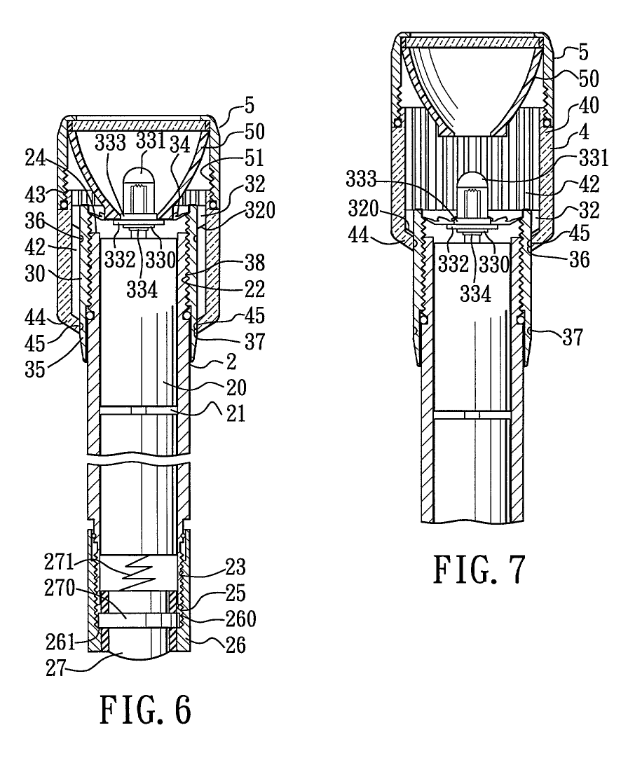

Referring to FIGS. 5 and 6, the preferred embodiment of a torch according to the present invention is shown to include a barrel 2, a lamp seat unit 3, a tubular coupling member 4, and a head cap 5.

The barrel 2 is formed as a hollow tube made of a conductive material, with an outer surface provided with an insulation layer. The barrel 2 confines a battery chamber 21 adapted to receive a battery unit 20 therein, and has a front end portion 24 and a rear end portion 25 opposite to the front end portion 24 in an axial direction. The front and rear end portions 24, 25 are respectively formed with screw threads 22, 23 at outer wall surfaces thereof. A sleeve 26 has an inner wall surface provided with a screw thread 260 for engaging the screw thread 23 on the rear end portion 25 of the barrel 2. The sleeve 26 is formed with an annular limiting flange 261 at a bottom end thereof. A tail cap switch 27 is mounted removably in the rear end portion 25 within the sleeve 26. The tail cap switch 27, which is formed as a conductive body, has an outer wall surface provided with an insulation layer, and includes a biasing member 271 adapted to urge the battery unit 20 towards the front end portion 24 of the barrel 2, and a conductive annular flange 270 projecting through the insulation layer to abut against the limiting flange 261, thereby closing the rear end portion 25 of the barrel 2. When the tail cap switch 27 is operated to enable the annular flange 270 to contact the barrel 2, electrical connection can be made between the barrel 2 and the battery unit 20 via the biasing member 271.

The lamp seat unit 3 includes a tubular seat member 30, a lamp 33, and a lamp positioning plate 34. The seat member 30, which is made of a conductive material, is mounted on the front end portion 24 of the barrel 2 and is in electrical contact with the barrel 2. The seat member 30 has a front section 31, a rear section 35 opposite to the front section 31 in the axial direction, and an outer wall surface 310 formed with at least one first locking groove 36 and at least one second locking groove 37 proximate to the front and rear sections 31, 35, respectively. The front section 31 is formed with at least one key projection 32, and an internal screw thread 38 for engaging the screw thread 22 on the front end portion 24 of the barrel 2. In this embodiment, the front section 31 is formed with four key projections 32. Each of the key projections 32 is formed with an inclined rear end face 320. The lamp 33 is held by the lamp positioning plate 34, and includes an insulated lamp base 330 and a lamp bulb 331 held in the lamp base 330. The lamp bulb 331 has a first lamp terminal 334 adapted to connect electrically with the battery unit 20, and a second lamp terminal (not visible) electrically insulated from the first lamp terminal 334. A conductive sleeve 333 is disposed on the lamp base 330 to contact electrically with the second lamp terminal, and is formed with an annular contact flange 332. The lamp positioning plate 34 is formed from a conductive metal sheet and is disposed in the front section 31 of the seat member 30 so as to connect electrically the second lamp terminal and the seat member 30 via the conductive sleeve 333. The lamp positioning plate 34 includes a ring portion 340 for holding the lamp 33 and for connecting with the contact flange 332, a plurality of radial contact parts 342 that extend radially and outwardly from the ring portion 340 for contacting the seat member 30, and a plurality of support arms 343 that extend radially and outwardly from the ring portion 340 and that extend to engage a front end face 311 of the seat member 30 to prevent displacement of the lamp positioning plate 34 along an inner wall surface of the seat member 30. The contact parts 342 have piercing ends 344 that pierce into the inner wall surface of the seat member 30 above the screw thread 38 for establishing electrical connection therewith. Preferably, the lamp positioning plate 34 is configured to have a diameter slightly greater than the internal diameter of the front section 31 of the seat member 30 so that the lamp positioning plate 34, by virtue of its own resilience, can abut tightly against the inner wall surface of the seat member 30. It can thus be seen that the lamp positioning plate 34, though simple in construction, is capable of facilitating mounting and positioning of the lamp bulb 33 in the seat member 30.

The coupling member 4 is made of a light transmittable material, preferably colored, and has a front end 40, a rear end 41, and an annular inner wall surface between the front and rear ends 40, 41. The front end 40 is formed with a screw thread 43 at an outer wall surface. The inner wall surface is formed with at least one spline groove 42. In this embodiment, a plurality of spline grooves 42 are formed on the inner wall surface of the coupling member 4 and are angularly displaced from each other. The coupling member 4 is sleeved around the seat member 30 such that the key projections 32 extend into and are slidable along the corresponding spline grooves 42. The rear end 41 of the coupling member 4 is formed with a radial inward end flange 44 that contacts tightly and slidingly the seat member 30 and that tapers inwardly to match the profile of the rear end face 320 of the key projection 32. The coupling member 4 is axially shiftable relative to the seat member 30 between a first position, where the end flange 44 contacts the rear section 35 of the seat member 30 (see FIG. 6), and a second position, where the end flange 44 abuts against the key projections 32 and mates with the rear end faces 320 of the key projections 32 to prevent removal of the coupling member 4 from the seat member 30 (see FIG. 7). The end flange 44 further has an inner periphery provided with at least one retaining member 45. In this embodiment, the retaining member 45 is a boss that is removably engaged within the first locking groove 36 of the seat member 30 when the coupling member 4 is disposed at the first position, and that is removably engaged within the second locking groove 37 when the coupling member 4 is disposed at the second position. Alternatively, the retaining member 45 can be a seal ring. In this case, the first and second locking grooves 36, 37 are annular grooves that respectively retain the seal ring 45 at the first and second positions. This alternative arrangement provides an enhanced waterproofing effect in terms of the engagement between the lamp seat unit 3 and the coupling member 4.

The head cap 5 is secured to the front end 40 of the coupling member 4 and is provided with a reflector 50 therein. The head cap 5 has an inner wall surface provided with a screw thread 51 for engaging threadedly the screw thread 43 on the front end 40 of the coupling member 4. The lamp 33 extends into the reflector 50 so that light may be directed axially when the coupling member 4 is disposed at the first position. The lamp 33 is located in the coupling member 4 and is at least partially withdrawn from the reflector 50 so that light can pass radially through the coupling member 4 when the coupling member 4 is disposed at the second position.

During assembly, the battery unit 20 is initially disposed in the battery chamber 21, and the tail cap switch 27 together with the sleeve 26 is mounted on the rear end portion 25 of the barrel 2 by virtue of engagement between screw threads 23 and 260. The seat member 30 is then mounted on the front end portion 24 of the barrel 2 by virtue of engagement between screw threads 38 and 22. Next, the lamp 33 is inserted and held in the ring portion 340 of the lamp positioning plate 34, and the lamp positioning plate 34 together with the lamp 33 is disposed in the front section 31 of the seat member 30 such that the first lamp terminal 334 contacts the positive terminal of the battery unit 20 to establish electrical connection, and such that the support arms 343 are supported on the front end face 311 and the piercing ends 344 of the contact parts 342 pierce into the inner wall surface of the seat member 30. Thereafter, the coupling member 4 is sleeved on the barrel 2 via the sleeve 26 and is slid towards the front section 31 of the seat member 30 such that the projections 32 extend into the corresponding spline grooves 42 and such that the retaining member 45 engages the second locking groove 37 to thereby position the coupling member 4 on the seat member 30 and provide a waterproofing effect. Lastly, the head cap 5 is mounted on the coupling member 4 by virtue of engagement between screw threads 51 and 43.

After completion of assembly of the preferred embodiment, since the biasing member 271 of the tail cap switch 27 urges the battery unit 20 towards the front end portion 24 of the barrel 2 under normal conditions, the conductive annular flange 270 will not come into contact with the rear end portion 25, thereby disconnecting the barrel 2 and the battery unit 21. In use, the user may press the tail cap switch 27 to cause the conductive annular flange 270 to intermittently contact an end face of the rear end portion 25 to thereby establish intermittent electrical connection, thus resulting in blinking of the lamp bulb 331. Alternatively, the sleeve 26 may be rotated relative to the barrel 2 towards the front end portion 24 of the latter to bring the conductive annular flange 270 into constant contact with the end face of the rear end portion 25 to generate a steady source of light.

Referring to FIG. 6, in a flashlight mode, the coupling member 4 is disposed at the first position, and the lamp 33 extends into the reflector 50 so that its light is directed axially. It is noted that in this operating mode, the light cannot pass through the coupling member 4.

The preferred embodiment may also serve as a lantern or a signaling baton. To switch from the flashlight mode to the lantern or baton mode, the coupling member 4 together with the head cap 5 is shifted axially away from the seat member 30 until the end flange 44 abuts against the rear end faces 320 of the key projections 32 and the retaining member 45 engages the first locking groove 36, as shown in FIG. 7. At this position, the seat member 30 is no longer concealed by the coupling member 4, and the lamp 33 is located in the coupling member 4 and is withdrawn from the reflector 50 so that light can pass radially through the coupling member 4. The arrangement of the retaining member 45 and the first locking groove 36 and the cooperation between the end flange 44 and the key projections 32 combine to limit axial movement of the coupling member 4 relative to the seat member 30 as well as to ensure water-tightness.

It is noted that, in practice, any suitable type of switch can be adopted in place of the tail cap switch 27 described herein.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A torch comprising:
a barrel adapted to receive a battery unit therein and having a front end portion and a rear end portion opposite to said front end portion in an axial direction;
a lamp seat unit including
a tubular seat member mounted on said front end portion of said barrel and having a front section formed with a key projection, and a rear section opposite to said front section in the axial direction,
a lamp positioning plate disposed in said front section of said seat member, and
a lamp held by said lamp positioning plate;
a tubular coupling member made of a light transmittable material and having a front end, a rear end and an annular inner wall surface between said front and rear ends, said inner wall surface being formed with a spline groove, said coupling member being sleeved around said seat member such that said key projection extends into and is slidable along said spline groove, said rear end of said coupling member being formed with a radial inward end flange that contacts tightly and slidingly said seat member, said coupling member being axially shiftable relative to said seat member between a first position, where said end flange contacts said rear section of said seat member, and a second position, where said end flange abuts against said key projection to prevent removal of said coupling member from said seat member; and
a head cap secured to said front end of said coupling member and provided with a reflector therein;
said lamp extending into said reflector so that light may be directed axially when said coupling member is disposed at the first position;
said lamp being located in said coupling member and at least partially withdrawn from said reflector so that light can pass radially through said coupling member when said coupling member is disposed at the second position.

2. The torch of claim 1, wherein said end flange tapers rearwardly, and said key projection is formed with an inclined rear end face for mating with said end flange.

3. The torch of claim 1, wherein said end flange has an inner periphery provided with a retaining member, and said seat member has an outer wall surface formed with a first locking groove to engage removably said retaining member when said coupling member is disposed at the first position, and a second locking groove to engage removably said retaining member when said coupling member is disposed at the second position.

4. The torch of claim 3, wherein said retaining member is a seal ring.

5. The torch of claim 1, wherein:
said lamp has a first lamp terminal adapted to connect electrically with the battery unit, and a second lamp terminal electrically insulated from said first lamp terminal;
said seat member is made of a conductive material; and
said lamp positioning plate is made of a conductive material and is in electrical contact with said second lamp terminal and said seat member.

6. The torch of claim 5, wherein said lamp positioning plate includes a ring portion for holding said lamp, and a plurality of radial contact parts that extend radially and outwardly from said ring portion for contacting said seat member.

7. The torch of claim 6, wherein said radial contact parts have piercing ends that pierce into an inner wall surface of said seat member for establishing electrical connection therewith.

8. The torch of claim 6, wherein said lamp positioning plate further includes a plurality of support arms that extend radially and outwardly from said ring portion and that extend to a front end face of said seat member.

9. The torch of claim 5, wherein said barrel is made of a conductive material and is in electrical contact with said seat member.

10. The torch of claim 9, further comprising a tail cap switch mounted on said rear end portion of said barrel and adapted to make or break electrical connection between said barrel and the battery unit.

11. The torch of claim 1, wherein said head cap is mounted threadedly on said front end of said coupling member.

12. The torch of claim 1, wherein said seat member is formed with an internal screw thread for engaging threadedly said front end portion of said barrel.
